(19) United States
(12) Patent Application Publication
(10) Pub. No.: US 2026/0332606 A1
(43) Pub. Date: Oct. 22, 2026

(54) Operational Prediction on Event Transitions

(71) Applicant: CrowdStrike, Inc., Sunnyvale, CA (US)

(72) Inventor: Vineet Sangar, Bothell, WA (US)

(73) Assignee: CrowdStrike, Inc., Sunnyvale, CA (US)

(21) Appl. No.: 19/184,186

(22) Filed: Apr. 21, 2025

(51) Int. Cl. H04L 9/40

(52) U.S. Cl. CPC H04L 63/1416; H04L 63/1425

(57) ABSTRACT

Event transition-based operational prediction greatly improves computer functioning. As a client device operates, an agent and/or cloud service monitors event transitions between sequential operating system events. The event transitions are compared to an event transition profile. The event transition profile represents historically normal event transitions associated with known safe/normal operation. If the event transition conforms to the event transition profile, then the client device is normally operating as historically observed and may be predicted as normal operation. If, however, the event transition fails to conform to the event transition profile, then the client device is not operating as historically observed and may be predicted as abnormal operation. Alerts and warnings may be generated to notify of abnormal client operation. The event transition-based operational prediction produces a faster and more accurate detection of the abnormal operation.

### BACKGROUND

The subject matter described herein generally relates to computers and to computer security and, more particularly, the subject matter relates to event detection and to anomaly response.

Cybersecurity threats are always increasing. It seems every day there is another cybersecurity hack that steals passwords, business data, and personal information. Indeed, many cybersecurity attacks exploit a previously unknown vulnerability. Conventional cybersecurity schemes are too slow to remedy near real time attacks.

### SUMMARY

Event transition-based prediction produces faster and more accurate detections of abnormal computer behavior. As a computer operates, operating system event transitions are monitored and compared to an event transition profile. The event transition profile represents historically normal event transitions that represent safe/normal computer operation. If the event transitions conform to the event transition profile, then the computer is predicted to be normally operating as historically observed. If, however, the event transitions fail to conform to the event transition profile, then the computer is not operating as historically observed for safe/normal computer operation. The event transitions may thus be predicted as evidence of abnormal computer operation. Because the computer system is not operating as historically observed, alerts and warnings may be generated to notify of abnormal operation. Monitoring of the event transitions is much faster, and far more accurate, in detecting suspicious operational behavior.

### BRIEF DESCRIPTION OF THE SEVERAL VIEWS OF THE DRAWINGS

The features, aspects, and advantages of operational prediction on event transitions are understood when the following Detailed Description is read with reference to the accompanying drawings, wherein:

FIGS. 1-2 illustrate some examples of monitoring operating system event transitions for abnormal operation;

FIG. 3 illustrates examples of client reporting;

FIG. 4 illustrates examples of service assessment;

FIG. 5 illustrates examples of a service response;

FIGS. 6-9 illustrates examples of an event transition profile;

FIGS. 10-11 illustrate more examples of a cybersecurity event transition assessment service;

FIGS. 12-13 illustrate examples of local endpoint prediction;

FIGS. 14-16 illustrate examples of methods or operations for monitoring event transitions; and

FIG. 17 illustrates a more detailed example of the operating environment.

### DETAILED DESCRIPTION

Some examples relate to predicting abnormal operations in computer systems. Every day we read of another computer virus or hack that results in lost data, stolen passwords, ransom demands, and ruined lives. These hacker schemes inflict damage within seconds. A cybersecurity event transition assessment service, though, far more quickly and accurately stops computer hacks. The cybersecurity event transition assessment service programs a computer system to monitor its host operating system for abnormal operation. The cybersecurity event transition assessment service, for example, determines an individual event transition between two sequential operating system events. The event transition may then be compared to historical event transitions that are known to represent safe/normal computer operation. The cybersecurity event transition assessment service then predicts whether the event transition is normal/safe operation or whether the event transition is abnormal operation. When, for example, the event transition resembles historical norms, then the cybersecurity event transition assessment service may predict that normal operation is being attempted. When, however, the event transition differs from historical norms, the cybersecurity event transition assessment service may predict that abnormal operation is being attempted. Any abnormal operation may be evidence of a potential cybersecurity threat. The cybersecurity event transition assessment service may thus generate alerts and warnings that abnormal operation has been detected. The cybersecurity event transition assessment service may thus hand-off the abnormal operation to other systems for deeper analysis.

The cybersecurity event transition assessment service is more accurate. The cybersecurity event transition assessment service generates more accurate results than conventional cybersecurity schemes. The cybersecurity event transition assessment service profiles millions and even billions of event transitions that have been historically categorized as safe/normal operation. The cybersecurity event transition assessment service may then compare current event transitions, in near real time, to the historically profiled event transitions. By monitoring individual and sequences of event transitions, the cybersecurity event transition assessment service predicts which event transitions are normal and which event transitions are abnormal. The conventional cybersecurity schemes, instead, only inspect a single event at a time. A single event, though, provides no contextual insight into usage and potential cybersecurity threats. Conventional cybersecurity schemes thus generate many false-positive detections which waste significant computer, network, and human resources. The cybersecurity event transition assessment service, instead, tracks and monitors individual and sequences of event transitions. The event transitions are compared to historical sequential norms. Should any current event transition differ from the historical norms, then abnormal operation may be predicted. Alerts are generated that warn of a potential cybersecurity threat.

Event transition-based operational prediction will now be described more fully hereinafter with reference to the accompanying drawings. Event transition-based operational prediction, however, may be embodied in many different forms and should not be construed as limited to the examples set forth herein. These examples are provided so that this disclosure will be thorough and complete and fully convey event transition-based operational prediction to those of ordinary skill in the art. Moreover, all the examples of event transition-based operational prediction are intended to encompass both structural and functional equivalents thereof. Additionally, it is intended that such equivalents include both currently known equivalents as well as equivalents developed in the future (i.e., any elements developed that perform the same function, regardless of structure).

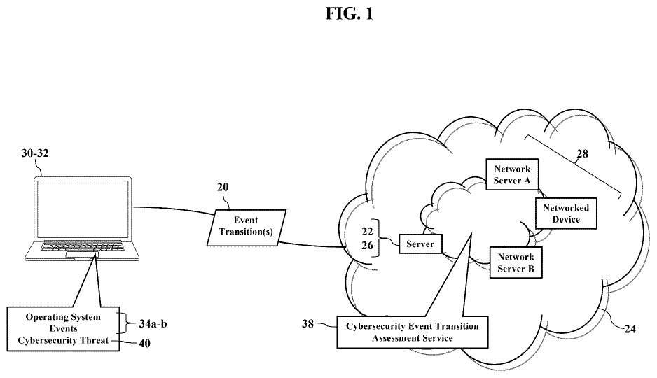

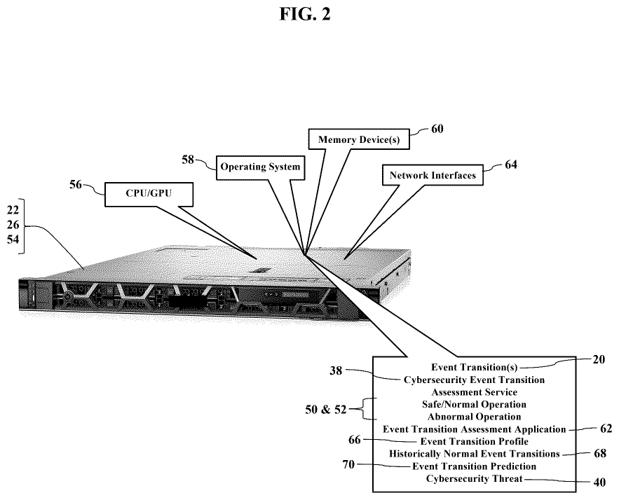

FIGS. 1-2 illustrate some examples of monitoring operating system event transitions 20 for abnormal operation. A computer system 22 operates in a cloud computing environment 24. FIG. 1 illustrates the computer system 22 as a server 26. The computer system 22, though, may be another processor-controlled device, as later paragraphs will explain. In this example, the server 26 communicates via the cloud computing environment 24 (e.g., public Internet, private network, and/or hybrid network) with other servers, devices, computers, or other networked members 28 operating within, or affiliated with, the cloud computing environment 24. The server 26 is programmed to monitor the event transitions 20 associated with an endpoint client device 30 (illustrated as a laptop computer 32). That is, when the client device 30 detects an abnormal event transition 20 (for example, from an operating system event 34a to another operating system event 34b, as later paragraphs will explain), the laptop computer 32 sends data representing the event transition 20 to a network address (e.g., IP address) associated with the cloud computing environment 24. The event transition 20 may indicate suspicious/malicious activity (such as malicious behavior, usage, or software/malware). So, prior to executing the event transition 20 (e.g., from operating system event 34a to operating system event 34b), the laptop computer 32 alerts or notifies the cloud computing environment 24 that the event transition 20 may represent a cybersecurity threat 36. When the cloud computing environment 24 receives the data describing the event transition 20, the cloud computing environment 24 provides a cybersecurity event transition assessment service 38 on behalf of a service provider. The networked members 28 of the cloud computing environment 24 (such as the server 26, for example) conduct a deeper analysis of the event transition 20. The cybersecurity event transition assessment service 38 confirms whether or not the event transition 20 represents the cybersecurity threat 36.

FIG. 2 illustrates more details of the cybersecurity event transition assessment service 38. While the networked members 28 of the cloud computing environment 24 may cooperatively provide the cybersecurity event transition assessment service 38 (as illustrated by FIG. 1), FIG. 2 illustrates a simple example involving only the server 26. When the cloud computing environment 24 receives the abnormal event transition 20, the networked members 28 may be programmed to route/forward/send the abnormal event transition 20 to the network/IP address assigned to the server 26 providing at least a portion of the cybersecurity event transition assessment service 38. The server 26 is programmed to analyze and to assess the event transition(s) 20. The server 26, in particular, may predict whether the event transition(s) 20 is/are normal/safe operation 50 (i.e., a false-positive report) or abnormal operation 52 (i.e., a true-positive report).

The server 26 may profile the event transition(s) 20. FIG. 2 illustrates the server 26 as a rack server 54 that is commonly installed in server rooms and in server farms. When the rack server 54 receives the event transition(s) 20, the rack server 54 is programmed to provide the cloud-based cybersecurity event transition assessment service 38. The rack server 54, for example, has at least one hardware processor 56 with cores (illustrated as “CPU/GPU”) that executes an operating system 58 stored in a memory device 60. The hardware processor 56 also executes an event transition assessment application 62 stored in the memory device 60. The rack server 54 also has network interfaces 64 to multiple communications networks (such as the cloud computing environment 24 illustrated in FIG. 1), thus allowing bi-directional communications with other networked devices. When the rack server 54 receives, or is notified of, the event transition(s) 20, the event transition assessment application 62 may be a computer program, instruction(s), or code that instructs or causes the rack server 54 to assess the event transition(s) 20 reported by the client device 30 (illustrated in FIG. 1). The event transition assessment application 62, for example, instructs or causes the hardware processor 56 to compare one or more of the event transitions 20 to an event transition profile 66. The event transition profile 66 represents historically normal event transitions 68. So, if the current event transition(s) 20 match, conform to, or otherwise satisfy the event transition profile 66, then the event transition assessment application 62 may generate an event transition prediction 70 of the normal/safe operation 50. That is, because the current event transition(s) 20 track(s) or resemble(s) historical event/behavioral norms, then the event transition assessment application 62 may operate as a predictor engine and predict that the current event transition(s) 20 is/are similarly the normal/safe operation 50. If, however, the current event transition(s) 20 do not match, fail to conform to, or otherwise fail to satisfy the event transition profile 66, then the current event transition(s) 20 may statistically/probabilistically lie outside the normal/safe operation 50. The event transition assessment application 62 may thus generate the event transition prediction 70 of the unsafe/abnormal operation 52. Indeed, because the current event transition(s) 20 do not resemble the normal/safe operation 50, the current event transition(s) 20 may be confirmed as the cybersecurity threat 36. The event transition assessment application 62 may further block or deny the event transition(s) 20, thus protecting the client device 30 from cybersecurity harm (as later paragraphs will explain).

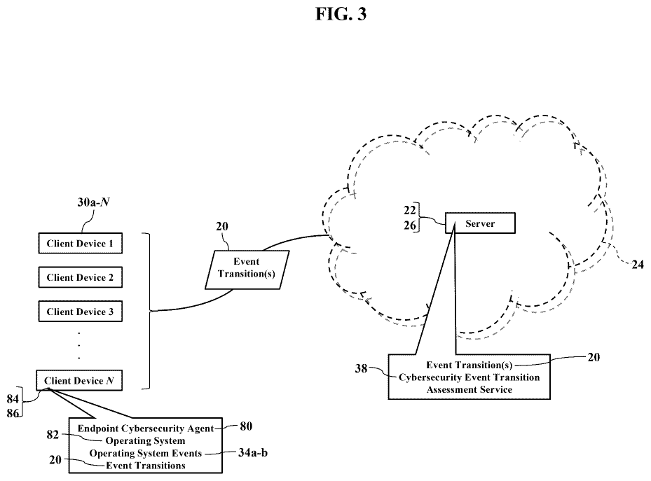

FIG. 3 illustrates more examples of client reporting. The digital cybersecurity event transition assessment service 38 may receive and collect reports of the event transitions 20 from thousands or even millions of customers and users. The cloud computing environment 24, in other words, may service and protect thousands or even millions of client devices 30 operating in the field. Such a large population of the client devices 30 is too difficult to illustrate, so FIG. 3 merely illustrates a simple example. Each client device 30a-N subscribes to the digital cybersecurity event transition assessment service 38 and downloads, stores, and executes an endpoint cybersecurity agent 80. The endpoint cybersecurity agent 80, in other words, is installed on the corresponding client device 30. The endpoint cybersecurity agent 80 includes computer program, code, or instructions that scan and monitor its corresponding client device 30 for the operating system event transition(s) 20 associated with the operating system events 34 (such as communications, processes, activities, behaviors, data values, usernames/logins, locations, contexts, and/or patterns that indicate computer activity). The endpoint cybersecurity agent 80, for example, interfaces with its host operating system 82 to establish event notifications of the hardware and software events 34. Each client device 30 stores the host operating system 82 and the endpoint cybersecurity agent 80 in a memory device 84, and each client device 30 has a hardware processor 86 that executes the operating system 82 and the endpoint cybersecurity agent 80. Should the event notifications indicate evidence of abnormal/suspicious/malicious event transitions 20, the endpoint cybersecurity agent 80 instructs its host client device 30 to hold, stall, delay, or postpone the event transition 20 (such as from the current operating system event 34a to the next/subsequent operating system event 34b). The endpoint cybersecurity agent 80 may further instruct the operating system 82 to report the event transition(s) 20 to the cloud computing environment 24. The endpoint cybersecurity agent 80, for example, may generate and send a service request for the cybersecurity event transition assessment service 38, and the service request specifies or indicates the event transition 20. The endpoint cybersecurity agent 80 may also instruct the operating system 82 to defer execution of the event transition 20 and, instead, await a service response.

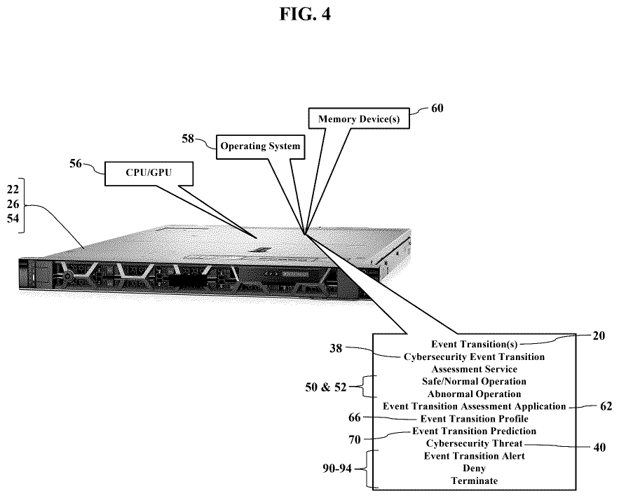

FIG. 4 illustrates more examples of service assessment. When the cloud computing environment 24 receives the event transition(s) 20, the cloud computing environment 24 assesses the event transition(s) 20 (as explained and illustrated with reference to FIGS. 1-3). Again, for simplicity, the networked members 28 may forward the event transition(s) 20 to the computer server 26 (again illustrated as the rack server 54). When the rack server 54 receives the event transition(s) 20, the event transition assessment application 62 instructs the rack server 54 to compare the event transition(s) 20 to the event transition profile 66. The event transition assessment application 62 may also instruct the rack server 54 to generate the event transition prediction 70. Again, if the client device's requested event transition 20 conforms to historical event transitional norms, then the event transition assessment application 62 may predict that the client device 30 is behaving as historically observed and represents the normal/safe operation 50. If, however, the client device's requested event transition 20 does not conform to historical event transitional norms, then the event transition assessment application 62 may predict that the client device 30 is abnormally behaving. The event transition assessment application 62 may thus generate the event transition prediction 70 of the unsafe/abnormal operation 52. The event transition assessment application 62 may flag the event transition 20 as the potential cybersecurity threat 36.

The cybersecurity event transition assessment service 38 may escalate the predicted unsafe/abnormal operation 52. When the event transition 20 is unequal to, does not match, does not satisfy, or lies outside of the event transition profile 66, then the event transition assessment application 62 may predict the unsafe/abnormal operation 52. The event transition 20, for example, does not conform to historical safe/normal event transitional observations, and/or the event transition 20 has been previously determined to be the unsafe/abnormal operation 52. Because the event transition 20 fails to conform to the event transition profile 66, the event transition assessment application 62 may further label or categorize the event transition 20 as the unsafe/abnormal operation 52. Moreover, because the event transition 20 does not conform to the event transition profile 66, the event transition assessment application 62 may generate an event transition alert 90 indicating the event transition 20 represents the unsafe/abnormal operation 52. The event transition alert 90 may be sent to whatever notification network/IP addresses that are specified or desired (e.g., a supervisory or notification system associated with the cloud computing environment 24). As more examples, because the event transition 20 does not conform to the event transition profile 66, the event transition assessment application 62 may have supervisory control, approval, or other authorization to at least one of deny 92 the event transition 20 and/or even terminate 94 a software process or application requesting the event transition 20 (again as later paragraphs will explain).

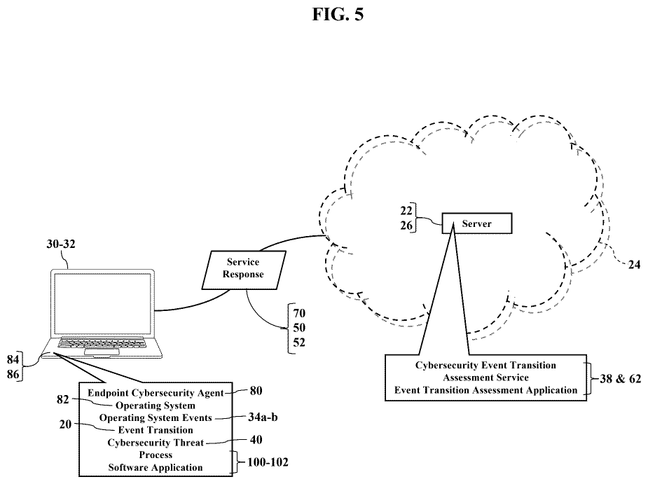

FIG. 5 illustrates examples of a service response. Once the event transition prediction 70 is generated, the cloud computing environment 24 may alert the client device 30 (again illustrated as the laptop computer 32). The event transition assessment application 62, for example, may instruct the computer server 26 to send the service response back to the client device 30. The service response, though, may indicate or specify the event transition prediction 70 (such as the normal/safe operation 50 or the unsafe/abnormal operation 52). When the laptop computer 32 receives the service response, the client's/host's operating system 82 may forward the service response to the endpoint cybersecurity agent 80. The endpoint cybersecurity agent 80 reads the service response and reacts to the event transition prediction 70. If, for example, the normal/safe operation 50 is predicted, then the endpoint cybersecurity agent 80 instructs the operating system 82 to proceed with executing the event transition 20 (such as from the current operating system event 34a to the next/subsequent operating system event 34b). If, however, the unsafe/abnormal operation 52 is predicted, then the endpoint cybersecurity agent 80 may protect the laptop computer 32 from the potential cybersecurity threat 36. The endpoint cybersecurity agent 80, for example, may instruct the host operating system 82 to deny the event transition 20. The operating system 82, in other words, may be commanded to not execute the requested event transition 20 from the operating system event 34a to the next/subsequent operating system event 34b. The endpoint cybersecurity agent 80 may even implement more protective measures, such as instructing the operating system 82 to terminate a software process 100 or software application 102 requesting the event transition 20. The endpoint cybersecurity agent 80, in plain words, stops the event transition 20 representing the cybersecurity threat 36.

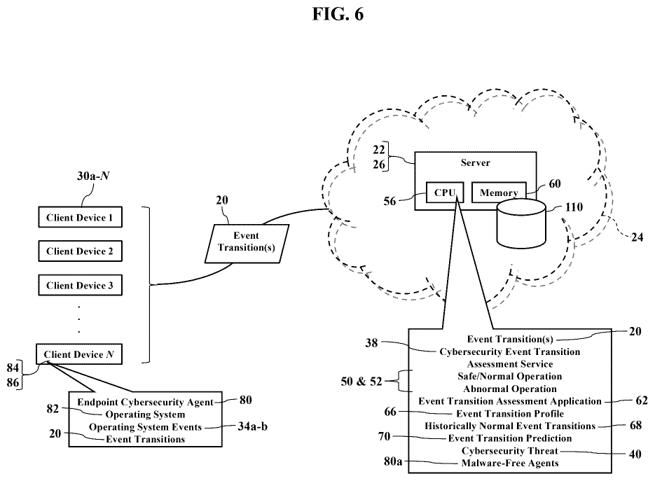

FIG. 6 illustrates more examples of the event transition profile 66. The event transition profile 66 may represent the historically normal event transitions 68. The event transition profile 66 defines, specifies, or represents predetermined or known event transitions 20 that have been assessed or prescribed as the normal/safe operation 50. The event transition profile 66, in other words, may describe habitual, routine, and/or harmless event transitions 20 associated with one or more safe/harmless historical contexts, user(s) inputs, locational data, computer behavior, and/or computer activities. The event transition profile 66 may thus represent historical logs, information, actions, inputs, operating system events, bits/bytes, values, averages/ranges, and/or other electronic data that is/are known to indicate the normal/safe operation 50. The event transition profile 66, as a simple example, may store or represent statistical/probabilistic ranges or values (e.g., ±3 σ standard deviations) describing past or historical event transitions 20 that have been previously logged and/or assessed as the normal/safe operation 50. Whatever electronic data represents the event transition 20, that electronic data may be compared to the event transition profile 66.

The cybersecurity event transition assessment service 38 may provide cloud logging and profiling. As the cloud computing environment 24 provides the cybersecurity event transition assessment service 38, the cloud computing environment 24 may log and store the event transitions 20 reported by service clients (illustrated as the client devices 30a-N). Because thousands or even millions of client devices 30 may subscribe to the cybersecurity event transition assessment service 38, the cloud computing environment 24 may collect and assess billions of the event transitions 20 reported by the subscribing client devices 30. Indeed, each day the cloud computing environment 24 may receive petabytes of operating system event transitions 20 reported by the endpoint cybersecurity agents 80 installed in the field. While other logging schemes may be used, FIG. 6 illustrates a clouded event transition log 110. FIG. 6, for simplicity, illustrates the event transition log 110 locally stored in the memory device 60 of the computer system/server 22/26. The event transition log 110, however, may be remotely stored and queried as a network database resource. Whatever the network architecture, the event transition log 110 stores the event transitions 20, their corresponding time stamps, and whatever other event data is desired. Because the event transition log 110 is available as a network resource, the event transition assessment application 62 may cause or instruct the computer server 26 to query the event transition log 110 for database records of interest. The event transition assessment application 62, for example, may query for and retrieve the event transitions 20, perhaps logged within a specified window of time. By retrieving the event transitions 20, and perhaps their corresponding time stamps, the event transition assessment application 62 may target specific event transitions 20 of interest and build the event transition profile 66 for specific needs.

The event transition profile 66, for example, may represent the normal/safe operation 50. The event transition assessment application 62, in particular, may query the event transition log 110 to identify the event transitions 20 reported by a subset of the cybersecurity agents 80. The event transition assessment application 62, as examples, may query for the event transitions 20 reported by malware-free cybersecurity agents (illustrated as reference numeral 80a). The malware-free cybersecurity agents 80a, for example, have been categorized as clean and have not detected/reported the unsafe/abnormal operation 52 within a desired timeframe (such as the previous 30 days). The corresponding historically normal event transitions 68 may thus be truly representative of the normal/safe operation 50. The event transition assessment application 62, for example, may generate a database query that specifies a query parameter requesting the event transitions 20 reported by the known-safe, malware-free cybersecurity agents 80a. The event transition profile 66 may thus accurately represent statistical ranges or values (e.g., ±3 σ standard deviations) describing the past or historically normal event transitions 68 that have been previously logged and/or assessed as the normal/safe operation 50. By perhaps excluding the event transitions 20 reported by recent/known unclean/infected cybersecurity agents 80, the event transition profile 66 more accurately represents the normal/safe operation 50. Because the event transition profile 66 more accurately represents the statistical/probabilistic normal/safe operation 50 (without the influence of unclean/infected cybersecurity agents 80), the cybersecurity event transition prediction 70 may have a higher confidence.

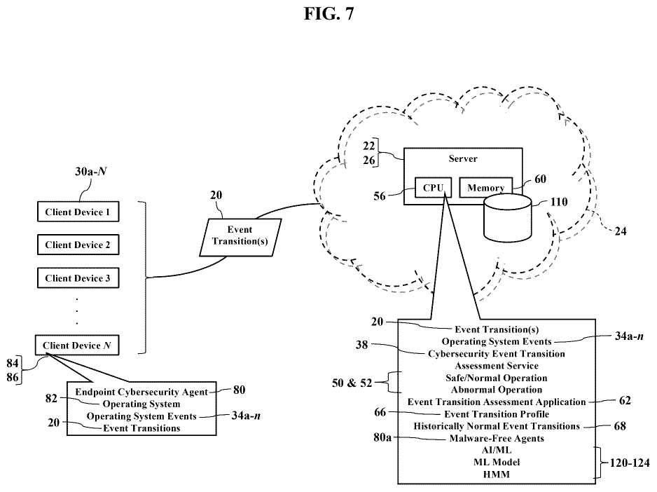

FIGS. 7-9 illustrate more examples of the event transition profile 66. While the cybersecurity event transition assessment service 38 may utilize other schemes, FIG. 7 illustrates artificial intelligence and/or machine learning (illustrated as AI/ML 120). The cybersecurity event transition assessment service 38, for example, may generate the event transition profile 66 using a machine learning model 122. The machine learning model 122 may be trained using data representing the historically normal event transitions 68 (representing the normal/safe operation 50) associated with the known-safe, malware-free cybersecurity agents 80a. The machine learning model 122, as more examples, may incorporate, call, and/or interface with a hidden Markov model (illustrated as HMM 124). The machine learning model 122, for example, may apply the HMM 124 to a timed sequence of the operating system event transitions 20 (describing, for example, sequential events 34a, 34b, 34c, . . . 34n). Malicious computer behavior, in other words, exhibits a sequence of anomalous operating system events 34 and, thus, the anomalous event transitions 20. The cybersecurity event transition assessment service 38 may thus model the sequential/serial event transitions 20 and detect the unsafe/abnormal operation 52 via anomalous Markov chains. The model 122/124, for example, may be trained using days, weeks, months, or even years of sequences of the operating system event transitions 20 (such as from a rate limited data feed). Then, for each non-malicious endpoint client device 30 (e.g., the known clean/safe/malware-free endpoint cybersecurity agent 80a), the cybersecurity event transition assessment service 38 may collect one or more sequences of the event transitions 20 in time (such as by querying the event transition log 110). Indeed, the cybersecurity event transition assessment service 38 may collect and aggregate sequences of the event transitions 20 associated with hundreds, thousands, or even millions of clean/safe/malware-free cybersecurity agents 80a. This large data set, representing normal sequences of the event transitions 20 reported by a large population of malware-free cybersecurity agents 80a, may then be used to determine transition frequencies/probabilities of the event transitions 20 between the operating system events 34.

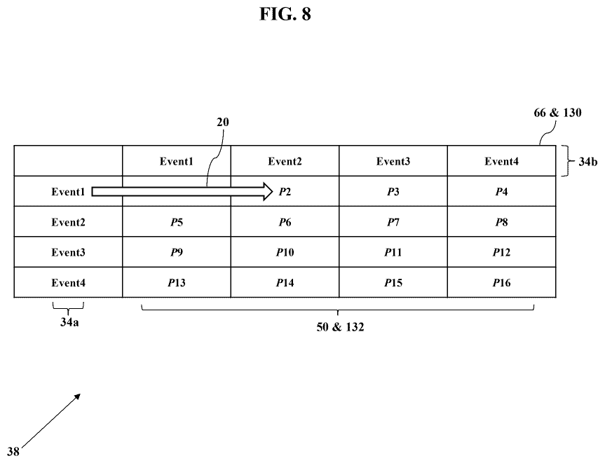

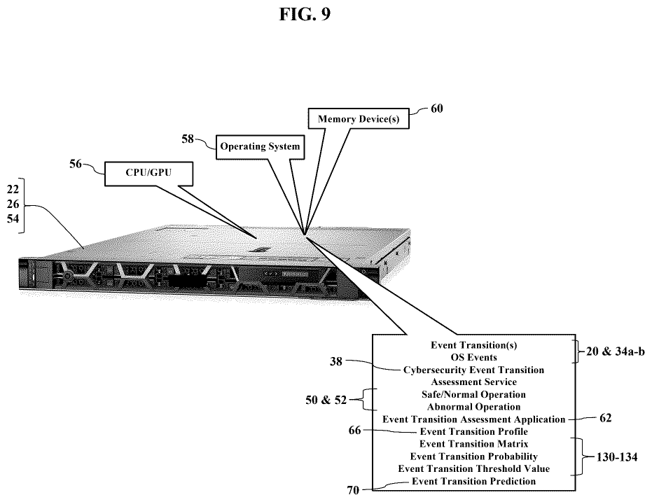

FIGS. 8-9, for example, illustrate an event transition matrix 130. The event transition matrix 130 is a simple, graphical representation of the event transition profile 66. While the cybersecurity event transition assessment service 38 may implement other representative schemes, the event transition matrix 130 is a small byte-sized, fast scheme for determining the normal/safe operation 50 (and, conversely, the unsafe/abnormal operation 52). As FIG. 8 illustrates, the event transition matrix 130 may be a relational table that maps, relates, or otherwise associates event transition probabilities 132 for the event transitions 20 that are known as the normal/safe operation 50. The event transition matrix 130, in other words, plots statistical probabilities for different event transitions 20 (such as probability “P2” for transition “Event1” to “Event2”) that are categorized as the normal/safe operation 50. FIG. 9 illustrates the event transition matrix 130 as being locally stored in the memory device 60 of the computer system/server 22/54, but the event transition matrix 130 may have other local/remote/network architectures. Regardless, as the event transition assessment application 62 assesses any client sequence of the event transitions 20 between the operating system events 34, the event transition assessment application 62 may merely consult the event transition matrix 130 and perform a fast lookup. The event transition assessment application 62, for example, may query the event transition matrix 130 for the event transition 20 requested by the client device 30 (illustrated in FIGS. 1, 3, & 5-7). The event transition matrix 130 thus returns or identifies the event transition probability 132 associated with the event transition 20. The event transition matrix 130, in other words, specifies the event transition probability 132 of the event transition 20 from event 34a to event 34b, according to the profiled normal/safe operation 50. The event transition assessment application 62 may then compare the event transition probability 132 to an event transition threshold value 134. The event transition threshold value 134, for example, represents a minimum acceptable event transition probability 132 associated with the profiled normal/safe operation 50. The event transition assessment application 62 may then generate the event transition prediction 70 based on the comparison of the event transition probability 132 to the event transition threshold value 134. If the event transition probability 132, for example, equals or exceeds the event transition threshold value 134, then the event transition assessment application 62 may predict that the event transition 20 represents the normal/safe operation 50. If, however, the event transition probability 132 is less than the event transition threshold value 134, then the event transition assessment application 62 may predict that the event transition 20 represents the unsafe/abnormal operation 52. Once the event transition prediction 70 is generated, the event transition assessment application 62 generates and sends the service response specifying the normal/safe operation 50 or the unsafe/abnormal operation 52 (as explained with reference to FIG. 5).

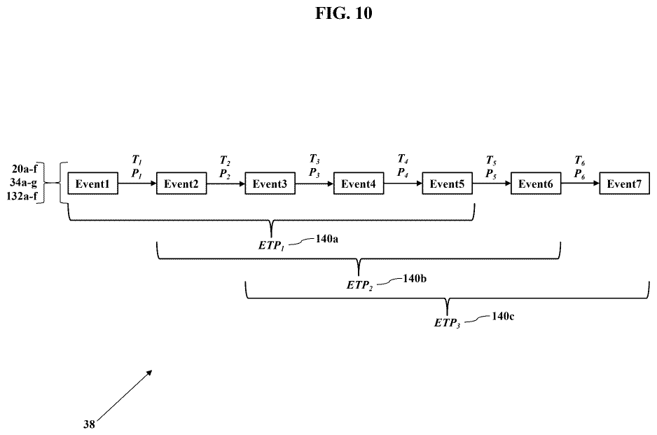

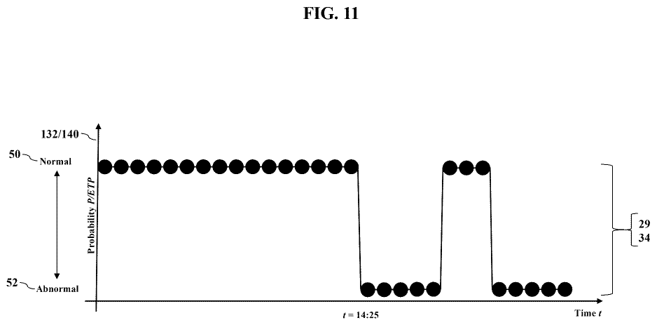

FIGS. 10-11 further illustrate the cybersecurity event transition assessment service 38. FIG. 10, for example, illustrates a sequence of seven (7) operating system events 34a-g reported by the non-malicious, malware-free endpoint client device 30 (e.g., hosting its corresponding endpoint cybersecurity agent 80, as previously explained with reference to FIGS. 3 & 5-7). The cybersecurity event transition assessment service 38 may consult the event transition matrix 130 (illustrated in FIGS. 8-9) for each corresponding event transition T₁₋₅ (illustrated as reference numerals 20a-f) and retrieve the corresponding event transition probabilities P₁₋₆ (illustrated as reference numerals 132a-f). The total event transition probability ETP (illustrated as reference numeral 140) of any sequence of the seven (7) operating system events 34a-g may thus be determined by multiplying their respective event transition probabilities P₁₋₆. The sequence of event transitions T₁₋₄, for example, has ETP₁=(P₁x P₂x P₃x P₄). The sequence of event transitions T₂₋₅ has ETP₂=(P₂x P₃x P₄x P₅). The sequence of event transitions T₃₋₆ has ETP₃=(P₃x P₄x P₅x P₆). The total event transition probability ETP (illustrated as reference numeral 140) may then be compared to the event transition threshold value 134 (illustrated in FIG. 9). Here, then, the event transition threshold value 134 may represent the minimum-acceptable total event transition probability ETP associated with the profiled normal/safe operation 50 (illustrated in FIG. 9). The cybersecurity event transition assessment service 38 may then generate the event transition prediction 70 (illustrated in FIG. 9) based on the comparison of the total event transition probability ETP to the event transition threshold value 134. If the total event transition probability ETP, for example, equals or exceeds the event transition threshold value 134, then the cybersecurity event transition assessment service 38 may predict that the corresponding event transitions 20 represent the normal/safe operation 50. If, however, the total event transition probability ETP is less than the event transition threshold value 134, then the cybersecurity event transition assessment service 38 may predict that the corresponding event transitions 20 represent the unsafe/abnormal operation 52. Indeed, if the total event transition probability ETP has a low (or zero) probability, then the event transitions 20 are a candidate for anomalous behavior (representing the unsafe/abnormal operation 52).

FIG. 11 thus illustrates a real time visualization of the event transitions 20. FIG. 11 plots the probability of each event transition 20 according to time t. FIG. 11, in other words, graphs the event transition probability P and/or the total event transition probability ETP (illustrated as reference numerals 132 and 140) for each event transition 20. Again, higher P/ETP probabilities 132/140 indicate the normal/safe operation 50, while lower P/ETP probabilities 132/140 indicate the unsafe/abnormal operation 52. The sequential timeline of the event transitions 20 thus also indicates normal or suspicious predicted computer operation.

Computer functioning is greatly improved. Cyberattacks on the endpoint client devices 30 are quick. Cyberattacks must therefore be quickly identified and quickly stopped (in near real time) to isolate the endpoint and to remedy the attack. Conventional technologies analyze the cybersecurity threat 32 as an isolated event without any context in which the event occurred. Isolated events, however, do not capture the prevalence of information present in the sequence of the event transitions 20. The cybersecurity event transition assessment service 38, in contradistinction to conventional schemes, analyzes the event transitions 20 from historical normal observations, thus providing a likelihood of normal, sequential computer behavior. The cybersecurity event transition assessment service 38, in particular, profiles the normal/safe operation 50 using the event transitions 20 reported by a population of the malware-free client devices 30 (as identified by their corresponding malware-free cybersecurity agents 80a). The event transitions 20 on an endpoint basis are collected and aggregated to profile normal behavior. These historical normal event transitions 68, revealing their corresponding event transition frequencies (as particularly illustrated by FIG. 11), provide the basis to test what is the P/ETP probability 132/140 of a certain number of the event transitions 20 to occur in sequence. If the probability of a sequence of event transitions 20 is lower than the event transition threshold value 134, then that corresponding endpoint client device 30 becomes a candidate for further cybersecurity examination. The cybersecurity event transition assessment service 38 thus very quickly, in near real time, detects the cybersecurity threats 36.

Computer functioning is further improved. Conventional anomaly-detection schemes utilize inflexible, rule-based detections. Rules-based approaches cannot contextualize normal verses abnormal behavior for each individual user and/or client device 30. The conventional anomaly-detection schemes focus on single event-level information, which is very inaccurate and results in high false-positive rates. The cybersecurity event transition assessment service 38, instead, causes the computer system 22 (such as the rack server 54) to monitor the sequence of the event transitions 20. The computer system 22 and/or the cloud computing environment 24, for example, may use the models 122/124 to find anomalous event transitions 20 as granular as the individual user level and/or device level. By aggregating the time-based event transitions 20, the computer system 22 encodes time-based statistics and information that can be used by the models 122/124. The computer system 22 thus reveals the intricate interconnections of the event transitions 20 over time. The computer system 22 thus more accurately identifies each user's/device's unique and individualized usage patterns based on the contextual activity. The computer system 22 more accurately identifies the normal/safe operation 50 and the unsafe/abnormal operation 52. The computer system 22 thus more accurately identifies the unsafe/abnormal operation 52, meaning malicious event transitions 20 are more quickly identified and resolved. The computer system 22 protects the cybersecurity event transition assessment service 38, the cloud computing environment 24, and/or the client device 30 from cybersecurity threats 36.

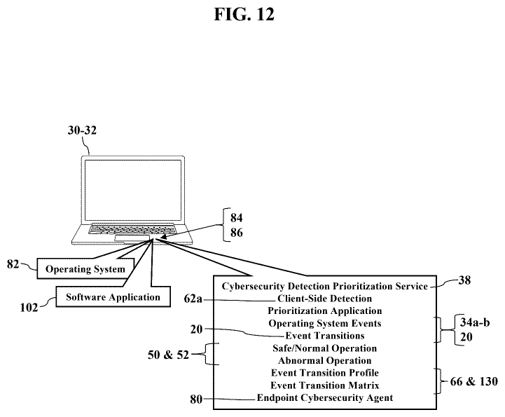

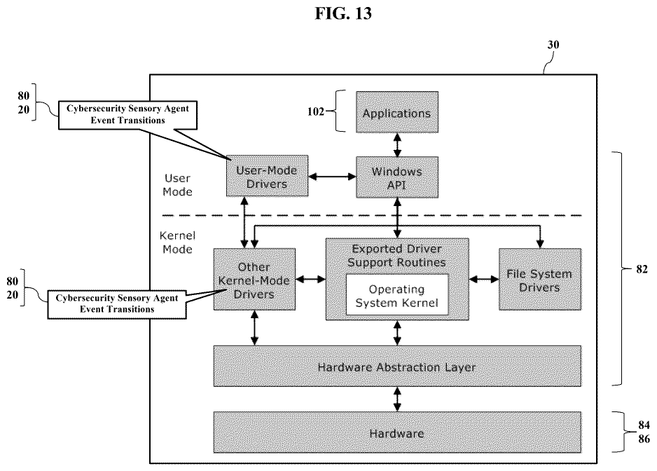

FIGS. 12-13 illustrate examples of local endpoint prediction. Here the endpoint cybersecurity agent 80 may also provide the cybersecurity event transition assessment service 38. The endpoint cybersecurity agent 80 may locally monitor the endpoint client device 30 (again illustrated as the laptop computer 32) for any malicious event transitions 20 that may potentially harm the laptop computer 32 (and/or the cloud computing environment 24 illustrated in FIGS. 1, 3 & 5-7). The laptop computer 32 downloads and installs the endpoint cybersecurity agent 80 as a software program that monitors the operating system 82 for evidence of the unsafe/abnormal operation 52. The operating system 82 notifies the endpoint cybersecurity agent 80 of the operating system events 34 requested by the locally-stored software applications 102. The endpoint cybersecurity agent 80 may then compare the event transition(s) 20 to the event transition profile 66 (perhaps represented by the event transition matrix 130). If the normal/safe operation 50 is predicted, then perhaps the endpoint cybersecurity agent 80 approves the event transition 20 (e.g., from the current operating system event 34a to the next/subsequent operating system event 34b). If, however, the unsafe/abnormal operation 52 is predicted, the endpoint cybersecurity agent 80 may block/deny the event transition 20. The endpoint cybersecurity agent 80 may additionally or alternatively terminate whatever software application 102 is requesting the event transition 20.

The endpoint cybersecurity agent 80 may be an antimalware driver. The endpoint cybersecurity agent 80, for example, may have kernel-level components having kernel-level permissions to a kernel of the operating system 82. The endpoint cybersecurity agent 80 may additionally have user-mode components having user-level permissions to a user mode of the operating system 82. The endpoint cybersecurity agent 80 may include computer program, code, or instructions that scan and monitor the client device 30 for the event transitions 20 that indicate evidence of a cybersecurity attack. Because the endpoint cybersecurity agent 80 has kernel-level permissions, the endpoint cybersecurity agent 80 may monitor any kernel-level activity and/or any user-mode activity conducted by the client device 30. The endpoint cybersecurity agent 80 may register for and receive kernel-level notifications and call backs from the kernel.

The model 122/124 may be trained. The cloud computing environment 24 may train the model 122/124 using device-specific, user-specific, and/or company/group-specific historically normal event transitions 68 previously logged/observed and associated with the normal/safe operation 50 (as explained with reference to FIG. 7). As a simple example, the model 122/124 may generate the event transition profile 66 using Gaussian probability distributions based on event transition training data. One or more standard deviations and confidence intervals may then be calculated to predict sequences of the event transitions 20 that represent the normal/safe operation 50. As the event transition assessment application 62 (and/or the cybersecurity agent 80) inspects the client-requested event transition(s) 20, statistical models may be used to predict that the client-requested event transition 20 conforms to, matches, or deviates from the event transition profile 66.

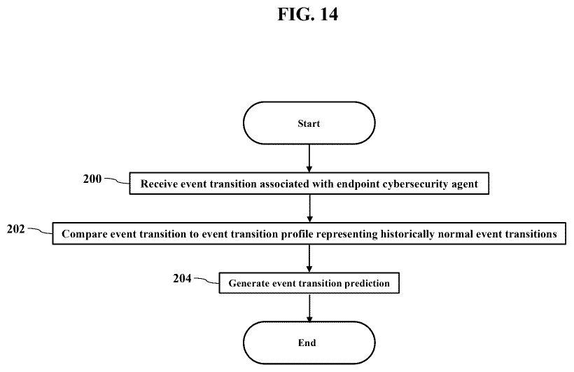

FIG. 14 illustrates examples of methods or operations that monitor the event transition 20. The computer system 22 receives the event transition 20 associated with the endpoint cybersecurity agent 80 (Block 200). The computer system 22 compares the event transition 20 to the event transition profile 66 representing the historically normal event transitions 68 (Block 202). The computer system 22 generates the cybersecurity event transition prediction 70 based on the comparing of the event transition 20 to the event transition profile 66 representing the historically normal event transitions 68 (Block 204).

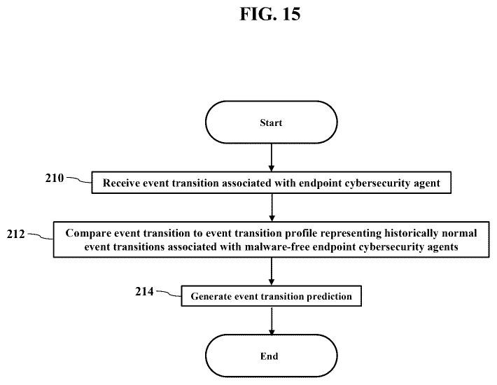

FIG. 15 illustrates more examples of methods or operations that monitor the event transition 20. The event transition 20 associated with the endpoint cybersecurity agent 80 is received (Block 210). The event transition 20 is compared to the event transition profile 66 representing the historically normal event transitions 68 associated with the malware-free endpoint cybersecurity agents 80b (Block 212). The cybersecurity event transition prediction 70 is generated based on the comparing of the event transition 20 to the event transition profile 66 representing the historically normal event transitions 68 associated with the malware-free endpoint cybersecurity agents 80b (Block 214).

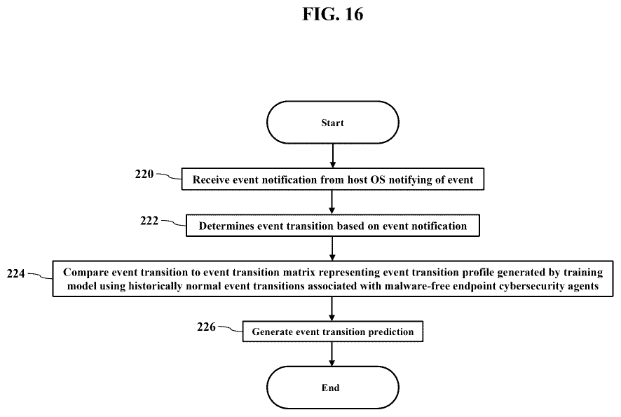

FIG. 16 illustrates even more examples of methods or operations that monitor the event transition 20. The endpoint cybersecurity agent 80 receives an event notification from the host operating system 82 notifying of the operating system event 34 (Block 220). The endpoint cybersecurity agent 80 determines the event transition 20 based on the event notification from the host operating system 82 (Block 222). The endpoint cybersecurity agent 80 compares the event transition 20 to the event transition matrix 130 representing the event transition profile 66 generated by training the model 122/124 using the historically normal event transitions 68 associated with the malware-free endpoint cybersecurity agents 80b (Block 224). The endpoint cybersecurity agent 80 generates the cybersecurity event transition prediction 70 based on the comparing of the event transition 20 to the event transition matrix 130 representing the event transition profile 66 (Block 226).

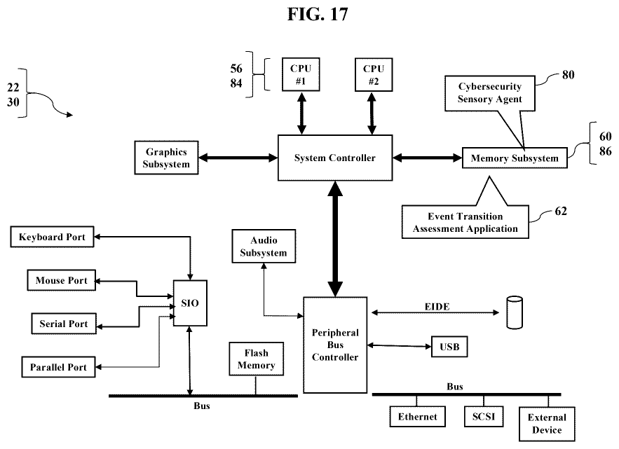

FIG. 17 illustrates a more detailed example of the operating environment. FIG. 17 is a more detailed block diagram illustrating the computer system 22 and the client device 30. The event transition assessment application 62 and/or the endpoint cybersecurity agent 80 is/are stored in the memory subsystem or device 60/86. One or more of the hardware processors 56/84 communicate with the memory subsystem or device 60/86 and execute the event transition assessment application 62 and/or the endpoint cybersecurity agent 80. Examples of the memory subsystem or device 54 may include Dual In-Line Memory Modules (DIMMs), Dynamic Random Access Memory (DRAM) DIMMs, Static Random Access Memory (SRAM) DIMMs, non-volatile DIMMs (NV-DIMMs), storage class memory devices, Read-Only Memory (ROM) devices, compact disks, solid-state, and any other read/write memory technology.

The computer system 22 and the client device 30 may have other embodiments.

This disclosure mostly discusses the computer system 22 as the server 26 and the client device 30 as the laptop computer 32. The cybersecurity event transition assessment service 38, however, may be easily adapted to other stationary/mobile computing devices, such as smartphones, switches/routers, tablet computers, smartwatches, and fitness bands. The cybersecurity event transition assessment service 38 may also be easily adapted to other embodiments of smart devices, such as a television, an audio device, a remote control, and a recorder. The cybersecurity event transition assessment service 38 may also be easily adapted to still more smart appliances, such as washers, dryers, and refrigerators. Indeed, as cars, trucks, and other vehicles grow in electronic usage and in processing power, the cybersecurity event transition assessment service 38 may be easily incorporated into any vehicular controller.

The above examples of the cybersecurity event transition assessment service 38 may be applied regardless of communications networking technology and networking environment. The cybersecurity event transition assessment service 38 may be easily adapted to stationary or mobile devices having wide-area networking (e.g., 4G/LTE/5G/6G cellular), wireless local area networking (WI-FI®), near field, and/or BLUETOOTH® capability. The cybersecurity event transition assessment service 38 may be applied to stationary or mobile devices utilizing any portion of the electromagnetic spectrum and any signaling standard (such as the IEEE 802 family of standards, GSM/CDMA/TDMA or any cellular standard, and/or the ISM band). The cybersecurity event transition assessment service 38, however, may be applied to any processor-controlled device operating in the radio-frequency domain and/or the Internet Protocol (IP) domain. The cybersecurity event transition assessment service 38 may be applied to any processor-controlled device utilizing a distributed computing network, such as the Internet (sometimes alternatively known as the “World Wide Web”), an intranet, a local-area network (LAN), and/or a wide-area network (WAN). The cybersecurity event transition assessment service 38 may be applied to any processor-controlled device utilizing power line technologies, in which signals are communicated via electrical wiring. Indeed, the many examples may be applied regardless of physical componentry, physical configuration, or communications standard(s).

The environment may utilize other processing component, configuration, or system.

For example, the cybersecurity event transition assessment service 38 may be easily adapted to execute by any desktop, mobile, or server central processing unit or chipset offered by INTEL®, ADVANCED MICRO DEVICES®, ARM®, APPLE®, TAIWAN SEMICONDUCTOR MANUFACTURING®, QUALCOMM®, NVIDIA®, or any other manufacturer. The computer system/device 22/30 may even use multiple hardware processors or chipsets, which could include distributed processors or parallel processors in a single machine or multiple machines. The hardware processor or chipset can be used in supporting a virtual processing environment. The hardware processor or chipset could include a state machine or logic controller. When any of the hardware processors or chipsets execute instructions to perform “operations,” this could include the central processing unit or chipset performing the operations directly and/or facilitating, directing, or cooperating with another device or component to perform the operations.

The cybersecurity event transition assessment service 38 may use packetized communications. When the computer system/device 22/20 and the cloud computing environment 24 communicate, information may be collected, sent, and retrieved. The information may be formatted or generated as packets of data according to a packet protocol (such as the Internet Protocol). The packets of data contain bytes of data describing the contents, or payload, of a message. A header of each packet of data may be read or inspected and contain routing information identifying an origination address and/or a destination address.

The cybersecurity event transition assessment service 38 may utilize any signaling standard. The cloud computing environment 24 may mostly use wired networks to interconnect the network members 28. However, the cloud computing environment 24 may utilize any communications device using the Global System for Mobile (GSM) communications signaling standard, the Time Division Multiple Access (TDMA) signaling standard, the Code Division Multiple Access (CDMA) signaling standard, the “dual-mode” GSM-ANSI Interoperability Team (GAIT) signaling standard, or any variant of the GSM/CDMA/TDMA signaling standard. The cloud computing environment 24 may also utilize other standards, such as the I.E.E.E. 802 family of standards, the Industrial, Scientific, and Medical band of the electromagnetic spectrum, BLUETOOTH®, low-power or near-field, and any other standard or value.

The cybersecurity event transition assessment service 38 may be physically embodied on or in a computer-readable storage medium. This computer-readable medium, for example, may include CD-ROM, DVD, tape, cassette, floppy disk, optical disk, memory card, memory drive, and large-capacity disks. This computer-readable medium, or media, could be distributed to end-subscribers, licensees, and assignees. A computer program product comprises processor-executable instructions for monitoring the event transition 20, as the above paragraphs explain.

The diagrams, schematics, illustrations, and tables represent conceptual views or processes illustrating examples of abnormal event transition detection. The functions of the various elements shown in the figures may be provided through the use of dedicated hardware as well as hardware capable of executing instructions. The hardware, processes, methods, and/or operating systems described herein are for illustrative purposes and, thus, are not intended to be limited to any particular named manufacturer or service provider.

As used herein, the singular forms “a,” “an,” and “the” are intended to include the plural forms as well, unless expressly stated otherwise. It will be further understood that the terms “includes,” “comprises,” “including,” and/or “comprising,” when used in this Specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, and so on, may be used herein to describe various elements, these elements should not be limited by these terms. These terms are only used to distinguish one element from another. For example, a first computer or container could be termed a second computer or container and, similarly, a second device could be termed a first device without departing from the teachings of the disclosure.

1. A method executed by a computer system that monitors an event transition, comprising:
receiving, by the computer system, the event transition associated with an endpoint cybersecurity agent;
comparing, by the computer system, the event transition to an event transition profile representing historically normal event transitions; and
generating, by the computer system, a cybersecurity event transition prediction based on the comparing of the event transition to the event transition profile representing the historically normal event transitions.

2. The method of claim 1, further comprising determining the event transition conforms to the event transition profile.

3. The method of claim 2, wherein in response to the determining that the event transition conforms to the event transition profile, further comprising categorizing the event transition as a normal operation.

4. The method of claim 1, further comprising determining the event transition fails to conform to the event transition profile.

5. The method of claim 4, wherein in response to the determining that the event transition fails to conform to the event transition profile, further comprising categorizing the event transition as an abnormal operation.

6. The method of claim 4, wherein in response to the determining that the event transition fails to conform to the event transition profile, further comprising generating an event transition alert that notifies of the event transition.

7. The method of claim 4, wherein in response to the determining that the event transition fails to conform to the event transition profile, further comprising at least one of blocking the event transition or terminating a process associated with the event transition.

8. At least one computer system that monitors an event transition, comprising:
at least one central processing unit; and
at least one memory device storing instructions that, when executed by the at least one central processing unit, perform operations, the operations comprising:
receiving the event transition associated with an endpoint cybersecurity agent;
comparing the event transition to an event transition profile representing historically normal event transitions associated with malware-free endpoint cybersecurity agents; and
generating a cybersecurity event transition prediction based on the comparing of the event transition to the event transition profile representing the historically normal event transitions associated with the malware-free endpoint cybersecurity agents.

9. The at least one computer system of claim 8, wherein the operations further comprise determining the event transition conforms to the event transition profile.

10. The at least one computer system of claim 9, wherein in response to the determining that the event transition conforms to the event transition profile, the operations further comprise categorizing the event transition as a normal operation.

11. The at least one computer system of claim 9, wherein in response to the determining that the event transition conforms to the event transition profile, the operations further comprise allowing the event transition.

12. The at least one computer system of claim 8, wherein the operations further comprise determining the event transition fails to conform to the event transition profile.

13. The at least one computer system of claim 12, wherein in response to the determining that the event transition fails to conform to the event transition profile, the operations further comprise categorizing the event transition as an abnormal operation.

14. The at least one computer system of claim 12, wherein in response to the determining that the event transition fails to conform to the event transition profile, the operations further comprise generating an event transition alert that notifies of the event transition.

15. The at least one computer system of claim 12, wherein in response to the determining that the event transition fails to conform to the event transition profile, the operations further comprise denying the event transition or terminating a process associated with the event transition.

16. A memory device storing instructions that, when executed by at least one hardware processor, perform operations that assess an event transition, the operations comprising:
receiving, by an endpoint cybersecurity agent, an event notification from an operating system notifying of an operating system event;
determining, by the endpoint cybersecurity agent, an event transition based on the event notification from the operating system;
comparing, by the endpoint cybersecurity agent, the event transition to an event transition matrix representing an event transition profile generated by training a machine learning model using historically normal event transitions associated with malware-free endpoint cybersecurity agents; and
generating, by the endpoint cybersecurity agent, a cybersecurity event transition prediction based on the comparing of the event transition to the event transition matrix representing the event transition profile.

17. The memory device of claim 16, wherein the operations further comprise downloading the event transition matrix representing the event transition profile.

18. The memory device of claim 16, wherein the operations further comprise:
determining the event transition conforms to the event transition matrix; and
allowing the operating system event.

19. The memory device of claim 16, wherein the operations further comprise:
determining the event transition fails to conform to the event transition matrix; and
denying the operating system event.

20. The memory device of claim 16, wherein the operations further comprise:
determining the event transition fails to conform to the event transition matrix; and
blocking a process associated with the operating system event.
